(19) United States
(12) Patent Application Publication
(10) Pub. No.: US 2009/0108975 A1
(43) Pub. Date: Apr. 30, 2009

(54) HIGH-VOLTAGE TRANSFORMER

(76) Inventors: Takesi Nomura, Hyogo (JP); Toshihiro Nakadai, Osaka (JP); Takaya Nagai, Kyoto (JP); Tadao Yubune, Hyogo (JP); Hisao Yamashita, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/299,654

(22) PCT Filed: Apr. 26, 2007
(86) PCT No.: PCT/JP2007/059017

§ 371 Date: Nov. 5, 2008

(30) Foreign Application Priority Data
May 8, 2006 (JP) 2006-128797
Nov. 7, 2006 (JP) 2006-301157

(51) Int. Cl. H01F 17/00

(52) U.S. Cl. 336/105

(57) ABSTRACT

A high-voltage transformer includes a core, a secondary coil bobbin surrounding the core, and a secondary winding which is wound on the secondary coil bobbin. The secondary winding includes a first partial secondary winding and a second partial secondary winding which are wound on the secondary coil bobbin. Between the first and second partial secondary windings of the secondary winding, there are provided insulators and parallel-connected diodes. The diodes are arranged in a direction away from the core. These diodes are not required to be resistant to high current, thus achieving a compact high-voltage transformer.

This application is a U.S. national phase application of PCT International Application PCT/JP2007/059017, filed Apr. 26, 2007

### TECHNICAL FIELD

The present invention relates to a high-voltage transformer which generates a high voltage.

### BACKGROUND ART

In recent years, various display elements such as plasma display panels and liquid crystal displays are used as graphic display devices besides cathode-ray tubes. These display elements are expected to increase in size and luminance, and hence, required to be driven by a higher voltage and a larger current.

FIG. 17 is a sectional view of conventional high-voltage transformer 8011 used in a CRT television, which is disclosed in Patent Document 1 shown below. High-voltage transformer 8011 includes core 2906 at its center, and cylindrical primary coil bobbin 2905 and cylindrical secondary coil bobbin 2903 concentrically arranged from the center of core 2906 outward. Secondary coil bobbin 2903 has secondary windings 2909 each divided into a plurality of layers and wound on it. These layers are isolated from each other via insulators and laminated in such a manner that the voltages generated in these layers have the same phase as each other.

High-voltage transformer 8011 also includes diode holder 2902, which holds a plurality of diodes 2901. Diodes 2901 include anode-side leads 2901A connected to the winding-finish ends of the layers, and cathode-side leads 2901B connected to the winding-start ends of the layers

FIG. 18A is a top view of diode holder 2902 used in a conventional high-voltage transformer disclosed in Patent Document 2. FIG. 18B is a sectional view of diode holder 2902 taken along line 18B-18B. Diodes 2901 are fixedly held in parallel with each other in diode holder 2902, which is a plastic molding. Diode holder 2902 includes ribs 2902C into which diodes 2901 are inserted and fixed at an appropriate distance from each other. Ribs 2902C include insertion portions 2902D through which to receive diodes 2901 and claw portions 2902E which fix diodes 2901. Insertion portions 2902D have inclined surfaces to facilitate the insertion of diodes 2901 into between ribs 2902C. Claw portions 2902E have surfaces inclined oppositely to the inclination of the surfaces of insertion portions 2902D so as to make diodes 2901 in ribs 2902C less likely to become detached therefrom.

FIG. 19 is an enlarged view of diode holder 2902 of a conventional high-voltage transformer disclosed in Patent Document 3. Diode holder 2902 includes end holding parts 2902A, which allow the ends of anode-side leads 2901A to be arranged substantially parallel to terminal pins of the secondary coil bobbin. The secondary coil bobbin includes pin fitting parts 2903A into which terminal pins 2903B are fitted. Terminal pins 2903B have the ends of the secondary windings wound thereon. Leads 2901A of diodes 2901 are soldered to the ends of the secondary windings wound around terminal pins 2903B. Leads 2901A of diodes 2901 and terminal pins 2903B are generally soldered to each other by soaking a plurality of them together in molten solder. The connected high-voltage transformer is covered with an outer case and filled with insulating resin because it generates a high voltage.

FIG. 20 is a sectional view of one of end holding parts 2902A. Leads 2901A of diodes 2901 are held substantially parallel to terminal pins 2903B.

FIG. 21 is a circuit diagram of a conventional high-voltage transformer 8105 disclosed in Patent Document 4. Between secondary windings 2909 are connected rectifier diodes 2901. In high-voltage transformer 8105, the secondary load current is supplied from terminal 8105A to display device 8105C via secondary windings 2909, diodes 2901, and terminal 8105B. When display device 8105C is a cathode-ray tube, the load current is 0.7 mA to 2.5 mA, so rectifier diodes 2901 generally have a rated capacity of 5 mA.

These days, however, display elements used as display device 8105C require a larger load current. This makes it necessary to use diodes resistant to high voltage and high current as rectifier diodes 2901.

Such diodes resistant to high voltage and high current have a volume about thirty times greater and are more expensive than general diodes.

FIG. 22 is a sectional view of conventional high-voltage transformer 8601 disclosed in Patent Document 5. High-voltage transformer 8601 includes high-voltage resistor 6101, case 6102 surrounding high-voltage resistor 6101, high-voltage connection terminal 6107, insulating resin 6110 having thermosetting properties such as epoxy resin, rib 6111 having a recess, ground-side lead 6112, and high-voltage-side lead 6113. Case 6102 is made of plastic resin and U-shaped. High-voltage resistor 6101 is formed of a ceramic substrate and includes ground-side electrode 6105 and high-voltage-side electrode 6106. U-shaped case 6102 is formed of under wall 6102U, left wall 6102L, right wall 6102R, and bottom wall 6102B.

FIG. 23 is a front view of case 6102 of high-voltage transformer 8601. FIG. 24 is a sectional view of case 6102 taken along line 24-24 of FIG. 23. FIGS. 25A and 25B are sectional views of case 6102 taken along line 25A-25A and line 25B-25B, respectively, of FIG. 23. U-shaped case 6102 has an open top to accommodate high-voltage resistor 6101. Rib 6111 protrudes from bottom wall 6102B of case 6102. The recess in rib 6111 holds the end of high-voltage resistor 6101 that is on the ground-side electrode 6105 side. Lead 6113 connected to high-voltage-side electrode 6106 of high-voltage resistor 6101 is fixedly connected to high-voltage connection terminal 6107. Thus, high-voltage resistor 6101 is held at two points so as to be arranged in the space of U-shaped case 6102.

In high-voltage transformer 8601, variations in fixing high-voltage-side lead 6113 to high-voltage connection terminal 6107 makes it hard to hold high-voltage resistor 6101 at the center of the space of case 6102. Consequently, as shown in FIG. 25A, high-voltage resistor 6101 is located closer to either right wall 6102R or left wall 6102L, making high-voltage resistor 6101 and case 6102 have different gaps 6114 and 6115 therebetween. As a result, thermosetting insulating resin 6110 to be poured around high-voltage resistor 6101 in the space of case 6102 is imbalanced between gaps 6114 and 6115. Insulating resin 6110 in liquid form is poured into transformer 8601 and hardened at a high temperature not exceeding the glass transition temperature of the resin. When insulating resin 6110 is hardened, high-voltage transformer 8601 is at a high temperature inside and the components are stable and balanced in volume.

The ceramic substrate of high-voltage resistor 6101 has a coefficient of linear expansion of 5×10⁻⁶/° C., which differs from the coefficient of linear expansion of 5×10⁻⁵/° C. of the epoxy resin used as insulating resin 6110. Therefore, when insulating resin 6110 is hardened and the temperature of high-voltage transformer 8601 decreases, shear stress is caused by the heat shrinkage in the vicinity of the ceramic substrate. When the shear stress exceeds the strength of the resin or the interface strength between the resin and the ceramic substrate, fine cracks occur in the resin. If insulating resin 6110 differs greatly in thickness on both sides of the ceramic substrate, when the insulating resin is contracted, different shear stresses are applied from both sides of the ceramic substrate. This causes the insulating resin to be stretched tighter on one side of the ceramic substrate. As a result, the shear stress exceeds the interface strength, causing fine cracks in the vicinity of the ceramic substrate. The fine cracks may grow if high-voltage transformer 8601 is subjected to continued and repeated thermal shock between high and low temperatures due to ON-OFF of the current applied to high-voltage transformer 8601 or changes in ambient temperature. The grown cracks may cause breakdown by being connected to each other between ground-side electrode 6105 and high-voltage-side electrode 6106 or between ground-side lead 6112 and high-voltage-side lead 6113, which are disposed at both ends in the longitudinal direction in the upper part of high-voltage resistor 6101.

FIGS. 26A and 26B show cracks 6121 to 6125 occurring in the vicinity of high-voltage resistor 6101 of high-voltage transformer 8601. Cracks 6121 to 6125 occur and grow in the vicinity of high-voltage resistor 6101 when a long-term thermal shock test is performed to repeatedly apply thermal shock. The cracks grown from the ground-side end and the high-voltage-side end of high-voltage resistor 6101 are further grown to become crack 6121. Crack 6121 may extend between ground-side electrode 6105 and high-voltage-side electrode 6106 and cause breakdown.

As shown in FIG. 23, U-shaped case 6102 has a free space above high-voltage resistor 6101, and therefore, thermosetting insulating resin 6110 is in a large volume above high-voltage resistor 6101. As a result, when the temperature of insulating resin 6 110 decreases, a large shear stress occurs at the high-voltage-side end of the ceramic substrate and tends to cause cracks in the vicinity of the high-voltage-side end of high-voltage resistor 6101.

Patent Document 1: Japanese Patent Unexamined Publication No. 2000-150278

Patent Document 2: Japanese Patent Unexamined Publication No. 2005-101579

Patent Document 3: Japanese Patent Unexamined Publication No. H04-123406

Patent Document 4: Japanese Patent Unexamined Publication No. H07-211564

Patent Document 5: Japanese Patent Unexamined Publication No. 2001-176727

### SUMMARY OF THE INVENTION

A high-voltage transformer includes a core, a secondary coil bobbin surrounding the core, and a secondary winding which is wound around the secondary coil bobbin. The secondary winding includes a first partial secondary winding and a second partial secondary winding which are wound on the secondary coil bobbin. Between the first and second partial secondary windings of the secondary winding, there are provided insulators and parallel-connected diodes. The diodes are arranged in a direction away from the core.

These diodes are not required to be resistant to high current, thus achieving a compact high-voltage transformer.

### BRIEF DESCRIPTION OF THE DRAWINGS

FIG. 1 is a sectional view of a high-voltage transformer according to a first embodiment of the present invention.

FIG. 2 is a circuit diagram of the high-voltage transformer according to the first embodiment.

FIG. 3 is a sectional view of the high-voltage transformer taken along line 3-3 of FIG. 1.

FIG. 4 is an enlarged view of terminal pins connected to leads ends of diodes of the high-voltage transformer according to the first embodiment.

FIG. 5A is a sectional view of the high-voltage transformer taken along line 5A-5A of FIG. 4.

FIG. 5B is a sectional view of the high-voltage transformer taken along line 5B-5B of FIG. 4.

FIG. 6A is an enlarged view of an end holding part of the high-voltage transformer according to the first embodiment.

FIG. 6B is an enlarged view of an end holding part for holding a lead end of a diode of a conventional high-voltage transformer.

FIG. 7 is an enlarged view of end holding parts connected to lead ends of diodes of a high-voltage transformer according to a second embodiment of the present invention.

FIG. 8 is a sectional view of one of the end holding parts taken along line 8-8 of FIG. 7.

FIG. 9 is an enlarged view of end holding parts of a high-voltage transformer according to a third embodiment of the present invention.

FIG. 10 is a sectional view of one of the end holding parts taken along line 10-10 of FIG. 9.

FIG. 11A is a partial sectional view of a high-voltage transformer according to a fourth embodiment of the present invention.

FIG. 11B is a circuit diagram of the high-voltage transformer according to the fourth embodiment.

FIG. 12 is a front view of a case of the high-voltage transformer according to the fourth embodiment.

FIG. 13 is another front view of the case of the high-voltage transformer according to the fourth embodiment.

FIG. 14 is a sectional view of the case taken along line 14-14 of FIG. 12.

FIG. 15A is a sectional view of the case taken along line 15A-15A of FIG. 12.

FIG. 15B is a sectional view of the case taken along line 15B-15B of FIG. 12.

FIG. 16A is a side view of the case of the high-voltage transformer according to the fourth embodiment.

FIG. 16B is another front view of the case of the high-voltage transformer according to the fourth embodiment.

FIG. 17 is a sectional view of a conventional high-voltage transformer.

FIG. 18A is a top view of a diode holder used in another conventional high-voltage transformer.

FIG. 18B is a sectional view of the diode holder taken along line 18B-18B of FIG. 18A.

FIG. 19 is an enlarged view of an end holding part of another conventional high-voltage transformer.

FIG. 20 is a sectional view of the end holding part of the high-voltage transformer of FIG. 19.

FIG. 21 is a circuit diagram of another conventional high-voltage transformer.

FIG. 22 is a sectional view of another conventional high-voltage transformer.

FIG. 23 is a front view of a case of the conventional high-voltage transformer.

FIG. 24 is a sectional view of the case taken along line 24-24 of FIG. 23.

FIG. 25A is a sectional view of the case taken along line 25A-25A of FIG. 23.

FIG. 25B is a sectional view of the case taken along line 25B-25B of FIG. 23.

FIG. 26A is a sectional view of a conventional high-voltage transformer in which cracks has occurred.

FIG. 26B is a sectional view of a conventional high-voltage transformer in which cracks has occurred.

### REFERENCE MARKS IN THE DRAWINGS

2001 diode
2001A cathode-side lead
2001B anode-side lead
2002 diode holder
2002B holding rib
2002C rib (first rib, second rib)
2003 secondary coil bobbin
2002A end holding part
2003B terminal pin (first terminal pin, second terminal pin)
2005 primary coil bobbin
2006 core
2009 secondary winding
2010 primary winding
2099 insulator
2109 partial secondary winding (second partial secondary winding)
2209 partial secondary winding (first partial secondary winding)
2309 partial secondary winding
6001 high-voltage resistor
6001A end (second end) of high-voltage resistor (insulating substrate)
6001B end (first end) of high-voltage resistor (insulating substrate)
6002 case
6006 ground-side electrode
6007 high-voltage-side electrode
6008 lower rib (first rib)
6009 upper rib (second rib)
6010 insulating resin
6011 supporting rib
6011A recess
6501 primary winding
6502 secondary winding
6503 core
6601 insulating substrate
6601A surface of insulating substrate (first surface)
6601B surface of insulating substrate (second surface)
6602 resistive element

### DETAILED DESCRIPTION OF PREFERRED EMBODIMENTS

### First Embodiment

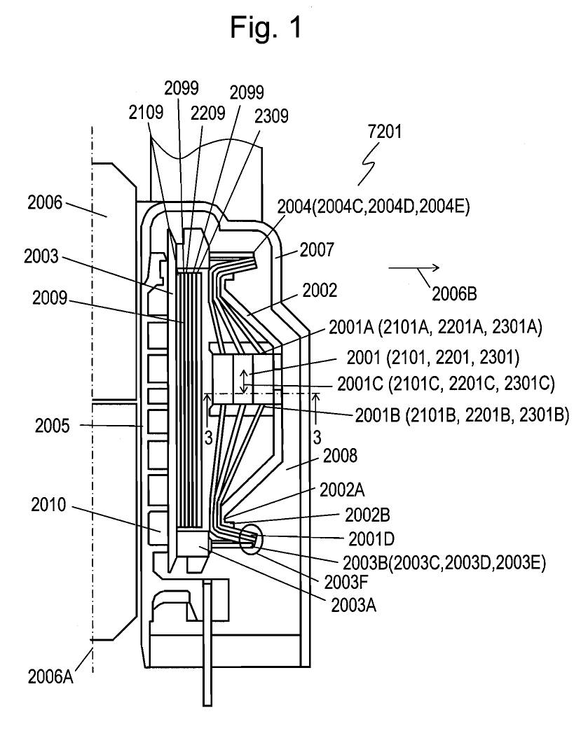

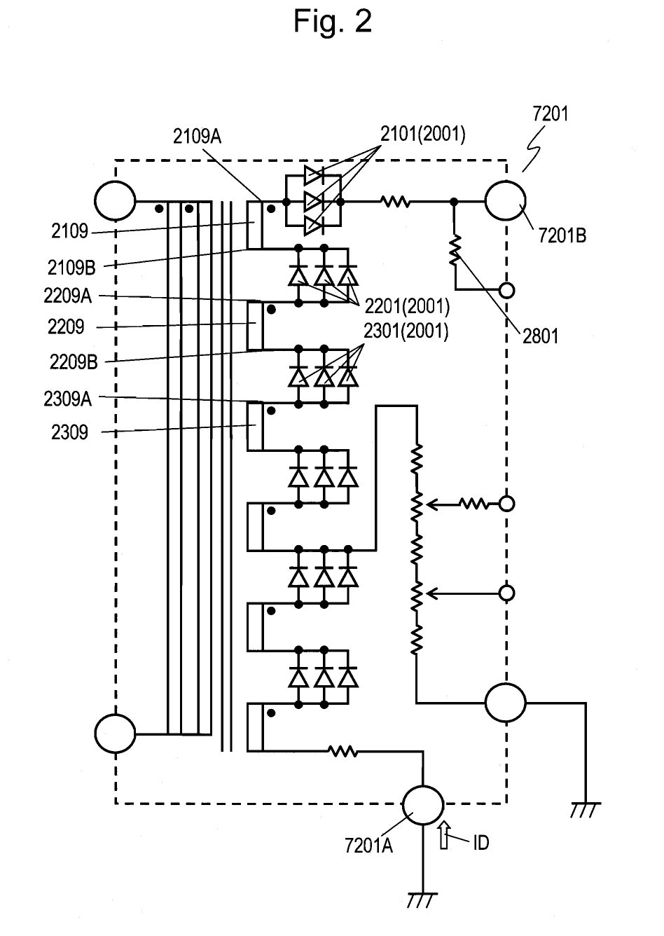

FIG. 1 is a sectional view of high-voltage transformer 7201 according to a first embodiment of the present invention. FIG. 2 is a circuit diagram of high-voltage transformer 7201. High-voltage transformer 7201 includes diodes 2001, diode holder 2002, secondary coil bobbin 2003, primary coil bobbin 2005, core 2006 made of ferrite, outer case 2007, insulating resin 2008, secondary winding 2009 and primary winding 2010. Diodes 2001 include diodes 2101, 2201, and 2301. Diodes 2001 (2101, 2201, and 2301) include anode-side leads 2001B (2101B, 2201B, and 2301B) and cathode-side leads 2001A (2101A, 2201A, and 2301A) extending oppositely from both ends thereof in direction 2001C (2101C, 2201C, and 2301C). Core 2006 has central axis 2006A with respect to which cylindrical primary coil bobbin 2005 and cylindrical secondary coil bobbin 2003 are concentrically arranged. Secondary winding 2009 wound on secondary coil bobbin 2003 is divided into a plurality of partial secondary windings including partial secondary windings 2109, 2209, and 2309 each in the form of layers. Partial secondary windings 2109, 2209, and 2309 are isolated from each other via insulators 2099.

The plurality of partial secondary windings of secondary winding 2009 are laminated in such a manner that the voltages generated in these layers have the same phase as each other. The winding-start ends and the winding-finish ends of the partial secondary windings are wound around terminal pins 2004 (2004C, 2004D, and 2004E) and 2003B (2003C, 2003D, and 2003E), respectively. More specifically, the winding-finish end of partial secondary winding 2309 is wound around terminal pin 2003D. Terminal pin 2003D is connected to anode-side leads 2301B of three diodes 2301. Cathode-side leads 2301A of diodes 2301 are connected to terminal pin 2004D around which the winding-start end 2209B of partial secondary winding 2209 is wound.

Winding-finish end 2209A of partial secondary winding 2209 is wound around terminal pin 2003E. Terminal pin 2003E is connected to anode-side leads 2201B of three diodes 2201. Cathode-side leads 2201A of diodes 2201 are connected to terminal pin 2004E around which winding-start end 2109B of partial secondary winding 2109 is wound.

Three diodes 2201 are connected in parallel with each other and arranged in the direction vertical to diode holder 2002, that is, in the direction away from core 2006 in such a manner that direction 2201C becomes parallel to central axis 2006A. Three diodes 2301 are connected in parallel with each other, and stacked in direction 2006B perpendicular to central axis 2006A in such a manner that direction 2301C becomes parallel to central axis 2006A.

Consequently, cathode-side leads 2001A (2201A and 2301A) extend in the same direction as each other, and anode-side leads 2001B (2201B and 2301B) extend in the same direction as each other from diodes 2001 (2201 and 2301).

Diode holder 2002 includes holding ribs 2002B of a square U shape and end holding parts 2002A. Holding ribs 2002B hold ends 2001D of anode-side leads 2001B (2201B and 2301B) of diodes 2001 (2201 and 2301). Ends 2001D are held substantially parallel to terminal pins 2003B fitted into pin fitting parts 2003A of secondary coil bobbin 2003. The number of diodes 2001 is not limited to 3, but may be 2 or larger than 3. When more diodes 2001 are needed, they can be stacked in direction 2006B, so that diode holder 2002 increases only in direction 2006B not in the width direction. Since diode holder 2002 does not increase in the width direction, there is no need to change the size of secondary coil bobbin 2003 to which diode holder 2002 is attached. This eliminates the need to greatly change the structure and shape of high-voltage transformer 7201. Leads 2001B of diodes 2001 and terminal pins 2003B of secondary coil bobbin 2003 are soldered to each other at connecting portions 2003F. Terminal pins 2003B connected to diodes 2201 and terminal pins 2003B connected to diodes 2301 are arranged substantially parallel to each other. These terminal pins 2003B arranged in parallel with each other can be soldered to the leads at the same time. These components are covered with outer case 2007 and filled with insulating resin 2008 because they generate a high voltage. Secondary winding 2009 is connected to high-voltage resistor 2801.

High-voltage transformer 7201 has terminal 7201A, which is connected to secondary winding 2009 via a resistor. Terminal 7201A supplies secondary load current ID to the display device via the partial secondary windings of secondary winding 2009, diodes 2001 (2101, 2201, and 2301), and terminal 7201B. When the secondary load current is 10 mA, three diodes 2001 (2101, 2201, and 2301) are supplied with a current of 3.3 mA each. When having a rated current of 5 mA, diodes 2001 (2101, 2201, and 2301) are supplied with a current smaller than the rated current. Diodes 2001 (2101, 2201, and 2301) are the same in properties and shape as each other. In reality, the properties and the number of diodes 2001 (2101, 2201, and 2301) are determined by applying derating in consideration of the skin effect and forward voltage variations due to parallel connection, and by measuring the temperatures of diodes 2001 (2101, 2201, and 2301). Thus, high-voltage transformer 7201 can output a large current without using expensive diodes capable of conducting a large current.

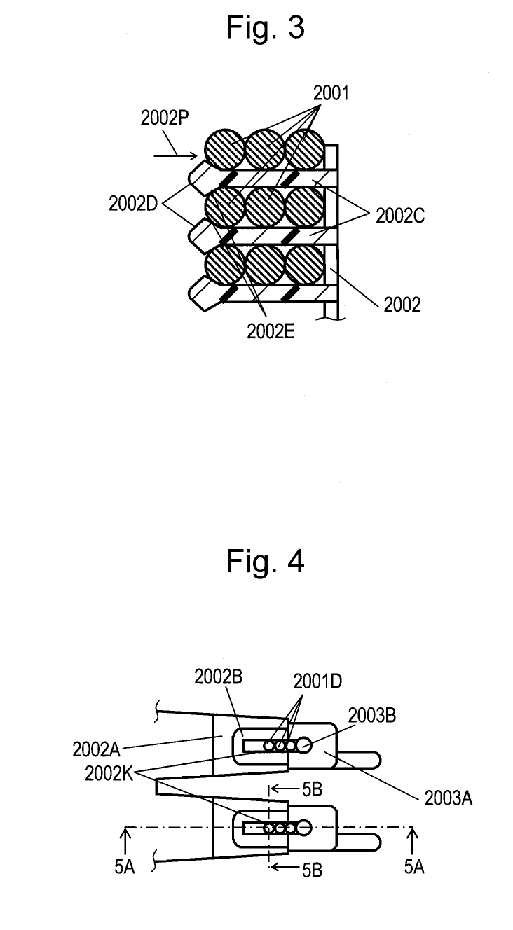

FIG. 3 is a sectional view of high-voltage transformer 7201 taken along line 3-3 of FIG. 1. Anode-side leads 2001B and cathode-side leads 2001A extend in direction 2001C from both ends of diodes 2001. Diodes 2001 are arranged in parallel with direction 2001C. Diode holder 2002 includes ribs 2002C into which diodes 2001 are inserted. Ribs 2002C include introduction portions 2002D having surfaces inclined with respect to direction 2002P so as to facilitate the insertion of diodes 2001 into between ribs 2002C in direction 2002P. Ribs 2002C further include claw portions 2002E, which have surfaces inclined oppositely to the inclination of the surfaces of introduction portions 2002D with respect to direction 2002P so as to make diodes 2001 in ribs 2002C less likely to become detached therefrom. In adjacent ribs 2002C, the spacings between introduction portions 2002D and between claw portions 2002E are smaller than in the remaining portions of adjacent ribs 2002C. The length of ribs 2002C is determined according to the number of diodes 2001. In high-voltage transformer 7201 of the first embodiment, three of diodes 2001 are arranged between each pair of adjacent ribs 2002C, but the number is not limited to three.

FIG. 4 is an enlarged view of terminal pins 2003B connected to ends 2001D of leads of diodes 2001. The ends of partial secondary windings 2109, 2209, and 2309 of secondary winding 2009 are wound around terminal pins 2003B. End holding parts 2002A of diode holder 2002 include square U-shaped holding ribs 2002B having grooves 2002K therein. Holding ribs 2002B surround grooves 2002K. Grooves 2002K have a width slightly larger than the diameter of the leads of diodes 2001 and a depth three times larger than the diameter of the leads of diodes 2001. Ends 2001D of the leads of three diodes 2001 are inserted into grooves 2002K and held aligned in holding ribs 2002B so as to be substantially parallelly opposed to and electrically connected to terminal pins 2003B.

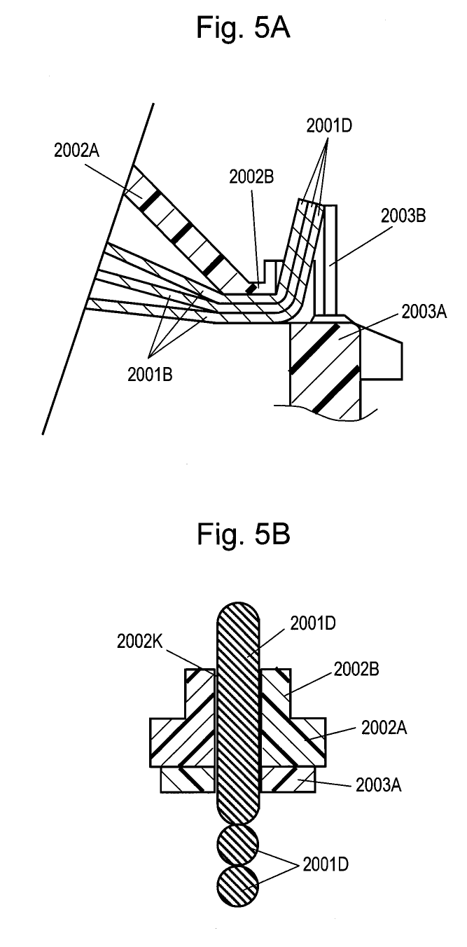

FIGS. 5A and 5B are sectional views of one of terminal pins 2003B taken along lines 5A-5A and lines 5B-5B, respectively, of FIG. 4. Ends 2001D of the leads of three diodes 2001 are surrounded from three sides by holding ribs 2002B which are thicker than diode holder 2002 and held substantially parallelly opposed to terminal pins 2003B.

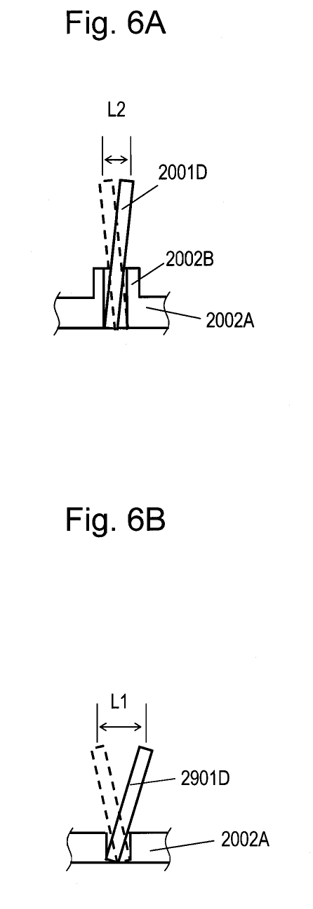

FIG. 6A is an enlarged view of one of ends 2001D of the leads of diodes 2001 of high-voltage transformer 7201. FIG. 6B is an enlarged view of one of ends 2901D of leads 2901A of diodes 2901 of conventional high-voltage transformer 8014 of FIG. 20. In FIG. 6B, dimension L1 within which the tips of ends 2901D of leads 2901A of diodes 2901 can be displaced is about 1.66 mm when the length of ends 2901D is 4 mm, the thickness of the diode holder is 1 mm, the width of end holding parts 2902A is 0.7 mm, and the diameter of the leads of diodes 2901 is 0.5 mm. On the other hand, in high-voltage transformer 7201 of FIG. 6A, dimension L2 within which the tips of ends 2001D of the leads of diodes 2001 can be displaced is about 0.87 mm when the height of holding ribs 2002B is 1 mm, the length of ends 2001D is 5 mm, the thickness of diode holder 2002 is 1 mm, the width of end holding parts 2002A is 0.7 mm, and the diameter of the leads of diodes 2001 is 0.5 mm. Thus, holding ribs 2002B of the first embodiment can reduce the displacement of the tips of the ends of the leads to about half the conventional displacement shown in FIG. 6B. As holding ribs 2002B become higher, ends 2001D of the leads of diodes 2001 are held closer to terminal pins 2003B with a smaller displacement. This allows ends 2001D of the leads of diodes 2001 to be easily soldered to terminal pins 2003B at the same time by solder dipping, thereby reducing soldering failure.

### Second Embodiment

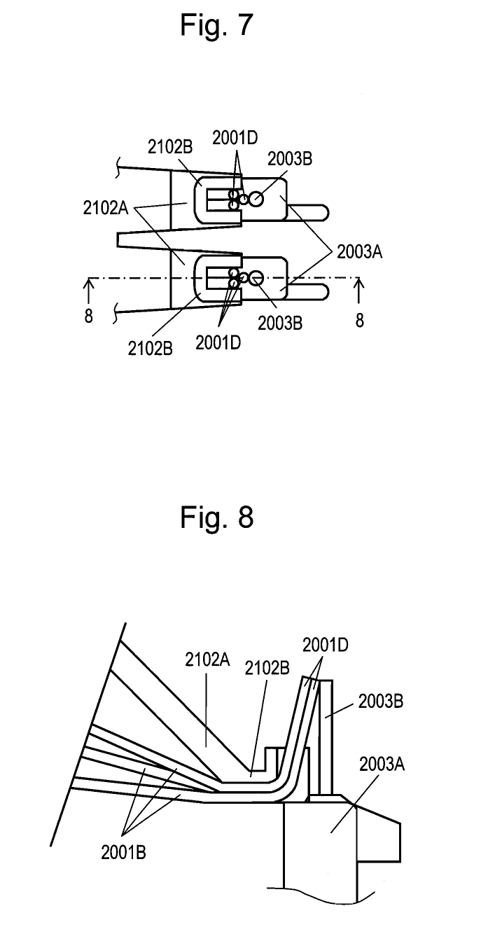

FIG. 7 is an enlarged view of end holding parts 2102A connected to ends 2001D of leads of diodes 2001 according to the second embodiment of the present invention. FIG. 8 is a sectional view of one of end holding parts 2102A taken along line 8-8 of FIG. 7. In FIGS. 7 and 8, the same components as those shown in FIGS. 1 to 6A are referred to with the same numerals and not described again. The ends of partial secondary windings 2109, 2209, and 2309 of secondary winding 2009 are wound around terminal pins 2003B fitted into pin fitting parts 2003A of secondary coil bobbin 2003. End holding parts 2102A include holding ribs 2102B of a square U shape. Holding ribs 2102B have square U-shaped grooves having a width slightly larger than twice the diameter of the leads of diodes 2001 and a depth larger than twice the diameter of leads 2001B of the diodes. Holding ribs 2102B hold leads 2001B of three diodes substantially parallel to terminal pins 2003B of secondary coil bobbin 2003 and in contact with each other in the shape of a regular triangle.

Square U-shaped holding ribs 2102B hold leads 2001B of three diodes 2001 so as to be substantially parallelly opposed to terminal pins 2003B held in secondary coil bobbin 2003. As the longer portions of leads 2001B of holding ribs 2102B are in contact with terminal pins 2003B, three leads 2001A are less likely to get separated from each other and are held closer to terminal pins 2003B. This allows leads 2001B of diodes 2001 to be easily soldered to terminal pins 2003B at the same time by solder dipping, thereby reducing soldering failure. Cathode-side leads 2001A of the diodes are held in the same manner as anode-side leads 2001B.

### Third Embodiment

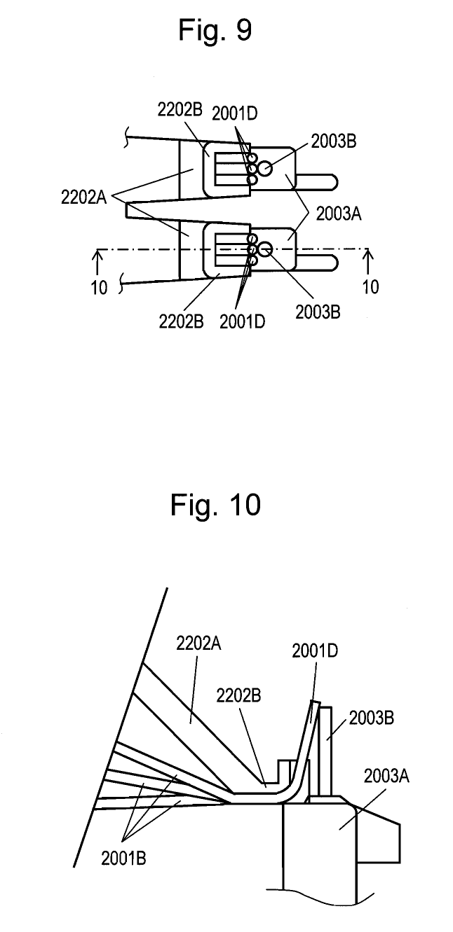

FIG. 9 is an enlarged view of end holding parts 2202A connected to end 2001D of leads 2001B of diodes 2001 of a high-voltage transformer according to a third embodiment of the present invention. FIG. 10 is a sectional view of one of end holding parts 2202A taken along line 10-10 of FIG. 9. In FIGS. 9 and 10, the same components as those shown in FIGS. 1 to 6A are referred to with the same numerals and not described again. The ends of partial secondary windings 2109, 2209, and 2309 of secondary winding 2009 wound on secondary coil bobbin 2003 are wound around terminal pins 2003B fitted into pin fitting parts 2003A. End holding parts 2202A include holding ribs 2202B of a square U shape. Holding ribs 2202B include grooves having a width three times larger than the diameter of leads 2001B and a depth larger than the diameter of leads 2001B. In each groove, leads 2001B of three diodes 2001 are held aligned and substantially parallelly opposed to terminal pins 2003B fitted into pin fitting parts 2003A of secondary coil bobbin 2003.

As the longer portions of leads 2001B of holding ribs 2202B are in contact with terminal pins 2003B, three leads 2001B are less likely to get separated from each other and are held closer to terminal pins 2003B. This allows leads 2001B of diodes 2001 to be easily soldered to terminal pins 2003B at the same time by solder dipping, thereby reducing soldering failure. Leads 2001 A of the diodes are held in the same manner as leads 2001B.

### Fourth Embodiment

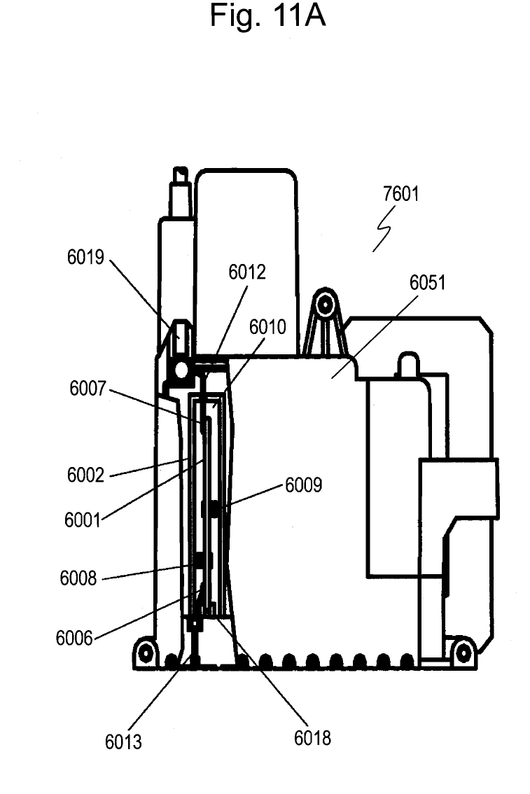

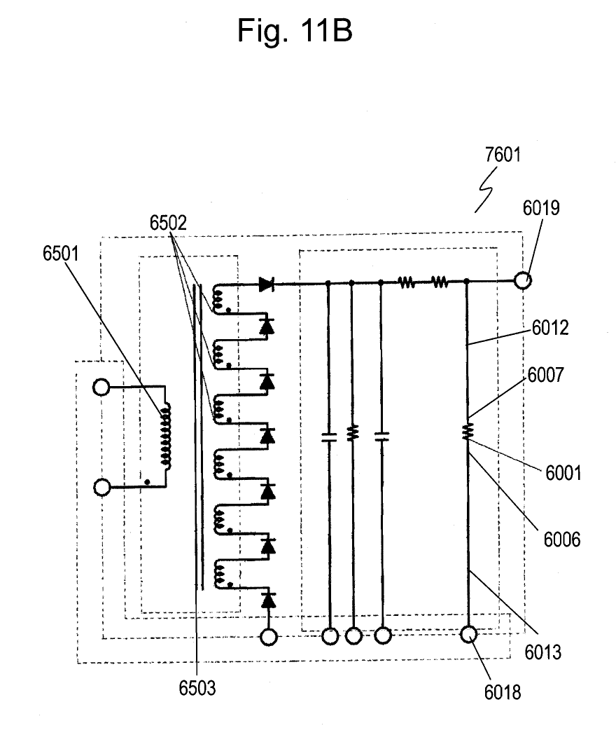

FIG. 11A is a partial sectional view of high-voltage transformer 7601 according to a fourth embodiment of the present invention. High-voltage transformer 7601 includes high-voltage resistor 6001, case 6002 surrounding high-voltage resistor 6001, lower rib 6008, upper rib 6009, insulating resin 6010 having thermosetting properties such as epoxy resin, supporting rib 6011, ground terminal 6018, high-voltage output cable 6019, high-voltage-side lead 6012 connected to high-voltage output cable 6019, and ground-side lead 6013 connected to ground terminal 6018. Case 6002 is resin-molded and box-shaped. High-voltage resistor 6001 includes ground-side electrode 6006 and high-voltage-side electrode 6007. Supporting rib 6011 has a recess and is resin-molded. High-voltage-side lead 6012 connects high-voltage-side electrode 6007 and high-voltage output cable 6019. Ground-side lead 6013 connects ground-side electrode 6006 and ground terminal 6018. These components are housed in outer case 6051.

FIG. 11B is a circuit diagram of high-voltage transformer 7601. The primary coil bobbin is fitted around the shaft of core 6503 and has primary winding 6501 wound thereon. The secondary coil bobbin is fitted around the primary coil bobbin and has secondary winding 6502 divided into a plurality of partial secondary windings wound thereon. High-voltage-side electrode 6007 of high-voltage resistor 6001 is connected to secondary winding 6502 which generates a high voltage.

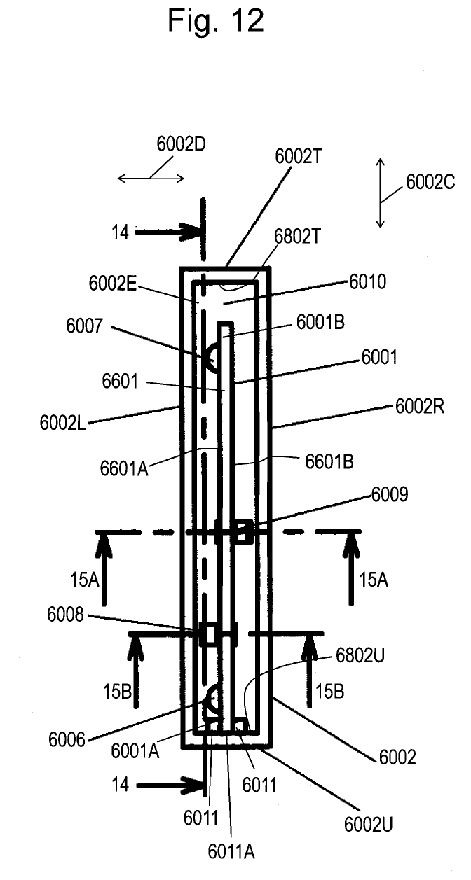

FIG. 12 is a front view of case 6002. Case 6002 is in the shape of a box having top wall 6002T, under wall 6002U, left wall 6002L, right wall 6002R, and bottom surface 6002B, thus forming space 6002E surrounding high-voltage resistor 6001. Top wall 6002T, under wall 6002U, left wall 6002L, and right wall 6002R together form a rectangle. In the rectangle, top wall 6002T and under wall 6002U form two opposite short sides in short-side direction 6002D, and left wall 6002L and right wall 6002R form two opposite long sides in long-side direction 6002C. Under wall 6002U is provided in its inner wall 6802U with supporting rib 6011 having recess 6011A. High-voltage resistor 6001 has end 6001A on the ground-side electrode 6006 side, which is inserted into recess 6011A so that supporting rib 6011 can support high-voltage resistor 6001. Top wall 6002T has inner wall 6802T, which is apart by a predetermined distance from end 6001B of high-voltage resistor 6001 on the high-voltage-side electrode 6007 side so that insulating resin 6010 can be interposed for insulation.

High-voltage resistor 6001 includes insulating substrate 6601 which is made of ceramic and has surface 6601A and surface 6601B opposite to substrate 6601. Space 6002E of case 6002 includes upper rib 6009 and lower rib 6008 which are arranged along long-side direction 6002C. Lower rib 6008 and upper rib 6009 are in contact with surface 6601A and surface 6601B, respectively, so as to support high-voltage resistor 6001. High-voltage-side electrode 6007 is disposed in the vicinity of end 6001B of insulating substrate 6601 of high-voltage resistor 6001. Ground-side electrode 6006 is disposed in the vicinity of end 6001A of insulating substrate 6601.

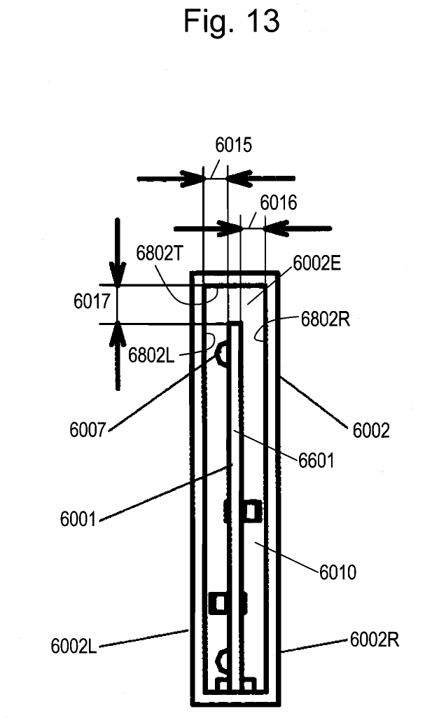

FIG. 13 is another front view of case 6002. In space 6002E of case 6002, high-voltage resistor 6001 is covered with insulating resin 6010. High-voltage resistor 6001 is disposed away from inner wall 6802R of right wall 6002R, inner wall 6802L of left wall 6002L, and inner wall 6802T of top wall 6002T by distances 6015, 6016, and 6017, respectively. In the fourth embodiment, distances 6015 and 6016 are equal to each other. The vicinity of high-voltage-side electrode 6007 of high-voltage resistor 6001 is not susceptible to insulation failure because only the thermosetting insulating resin 6010 filled within distance 6017 is in contact with high-voltage resistor 6001.

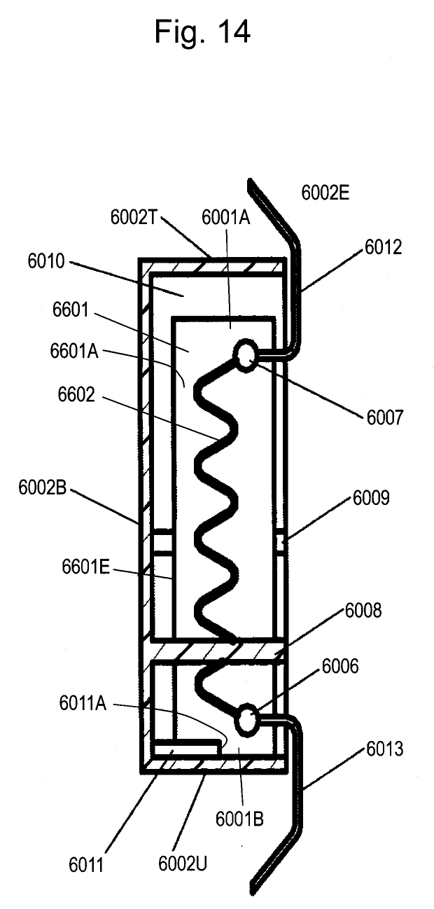

FIG. 14 is a sectional view of case 6002 taken along line 14-14 of FIG. 12. High-voltage resistor 6001 includes resistive element 6602 printed on surface 6601A of insulating substrate 6601 and connected between high-voltage-side electrode 6007 and ground-side electrode 6006. Lower rib 6008 and upper rib 6009 extend from bottom surface 6002B beyond high-voltage resistor 6001. High-voltage resistor 6001 is fixed by inserting end 6001A into recess 6011A formed in rib 6011 and sandwiching end 6001A between lower rib 6008 and upper rib 6009. Insulating substrate 6601 of high-voltage resistor 6001 has end 6601E which is close to and opposed to bottom surface 6002B. The distance between rib 6008 and ground-side electrode 6006 is shorter than the distance between rib 6008 and high-voltage-side electrode 6007. The distance between rib 6009 and high-voltage-side electrode 6007 is longer than one third of the distance between ends 6001A and 6001B of insulating substrate 6601.

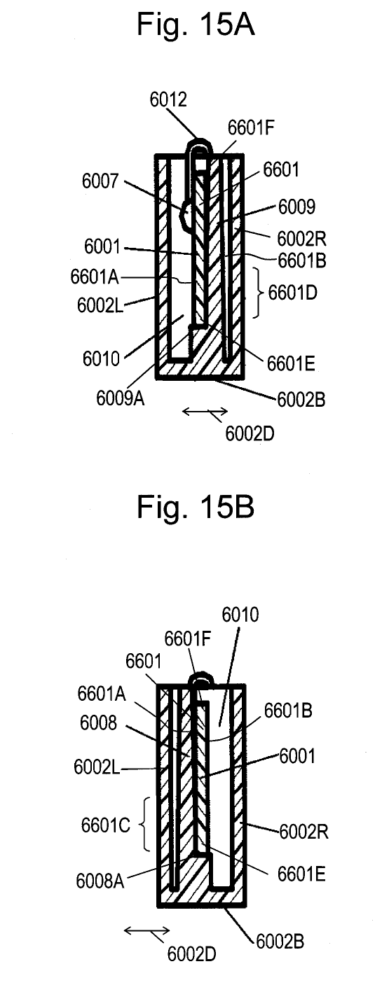

FIGS. 15A and 15B are sectional views of case 6002 taken along line 15A-15A and line 15B-15B, respectively, of FIG. 12. Lower rib 6008 and upper rib 6009 include step portions 6008A and 6009A, respectively, which are in contact with end 6601E of insulating substrate 6601 of high-voltage resistor 6001 so as to support insulating substrate 6601. Insulating substrate 6601 is in contact with lower rib 6008 along portion 6601C, which extends from end 6601E to the point corresponding to about one third of the width of insulating substrate 6601. The portion of insulating substrate 6601 farther from end 6601E than portion 6601C is not in contact with lower rib 6008. At end 6601F, which is opposite to end 6601E, insulating substrate 6601 is away from lower rib 6008 by about 0.5 mm. In the same manner, insulating substrate 6601 is contact with upper rib 6009 along portion 6601C, which extends from end 6601E to the point corresponding to about one third of the width of insulating substrate 6601. The portion of insulating substrate 6601 farther from end 6601E than portion 6601D is not in contact with upper rib 6009. At end 6601F opposite to end 6601E, insulating substrate 6601 is away from upper rib 6009 by about 0.5 mm. Thus, lower rib 6008 and upper rib 6009 are tapered from bottom surface 6002B, that is, from step portions 6008A and 6009A, respectively. The tapered shape allows high-voltage resistor 6001 to be stably held at the center of case 6002 in short-side direction 6002D by being supported at three points: rib 6011, the bottom in the vicinity of step portion 6008A of lower rib 6008, and the bottom in the vicinity of step portion 6009A of upper rib 6009. The tapered shape also makes it easy to take case 6002 out of a mold when it is resin-molded.

As shown in FIGS. 15A and 15B, lower and upper ribs 6008 and 6009 protrude from bottom surface 6002B of case 6002 and are away from top wall 6002T, under wall 6002U, left wall 6002L, and right wall 6002R.

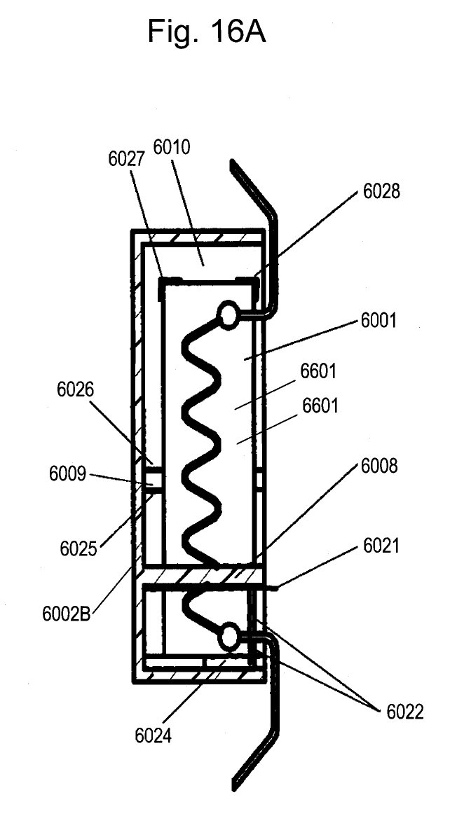

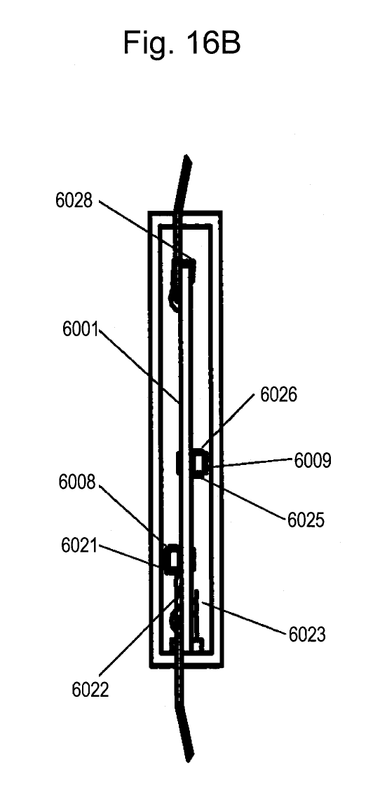

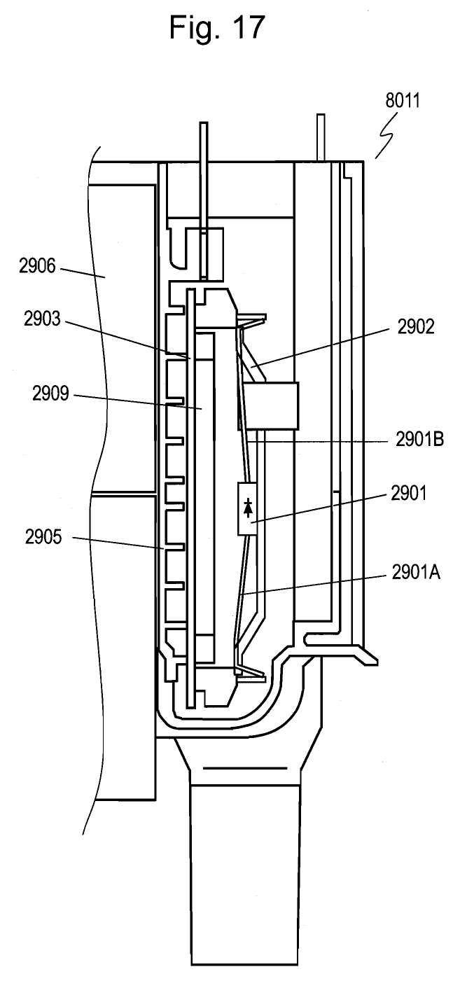

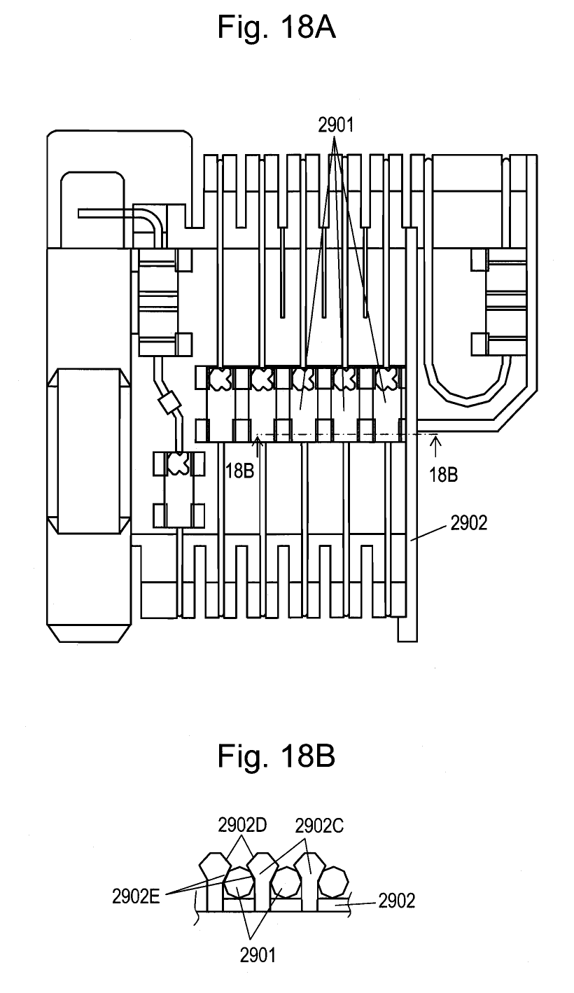

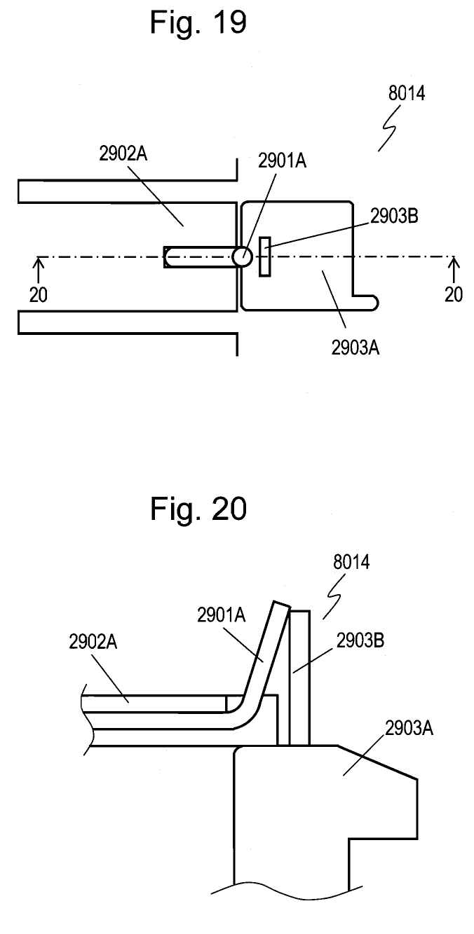

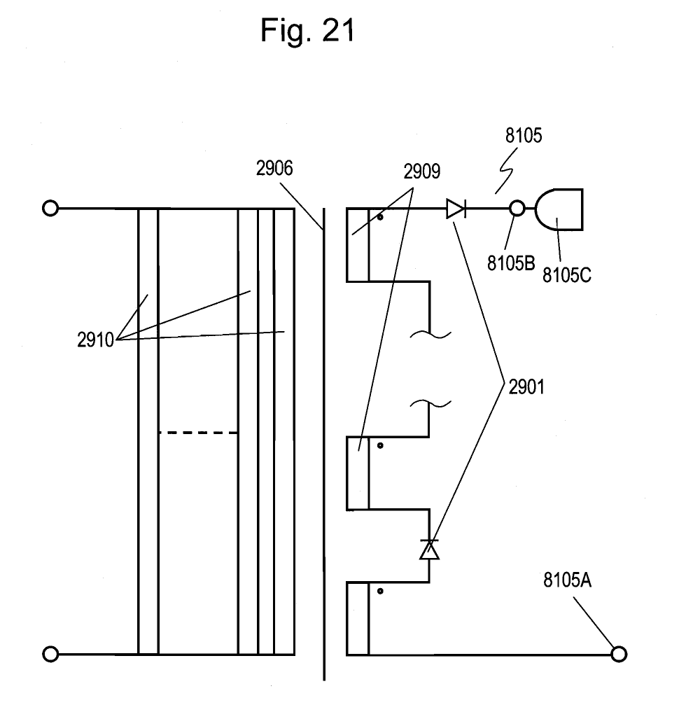

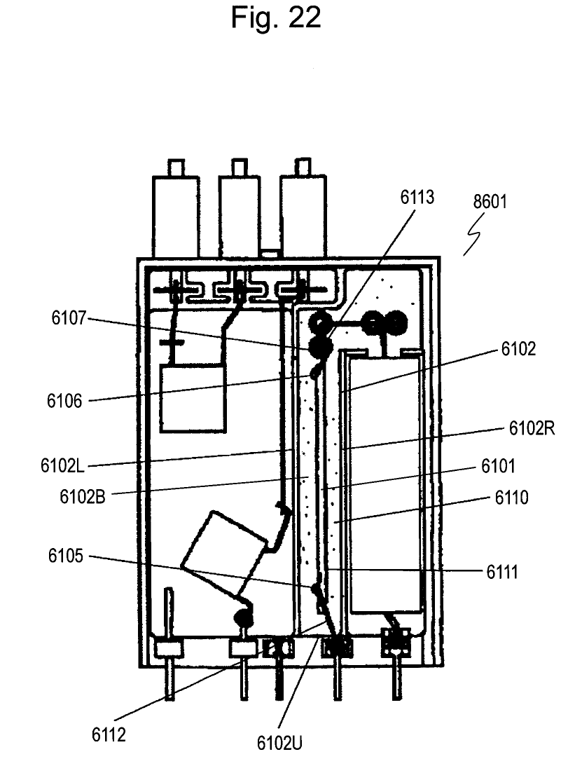

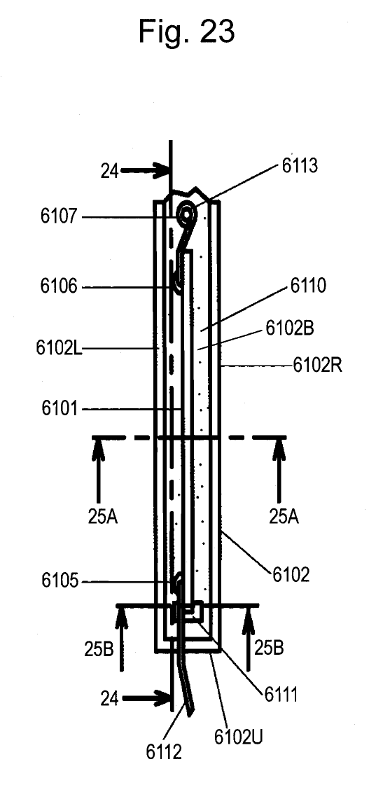

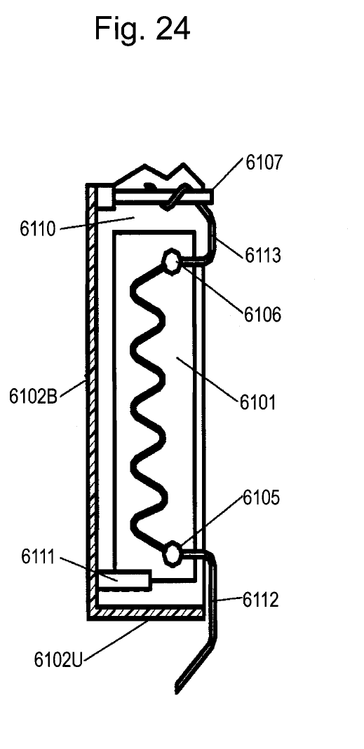

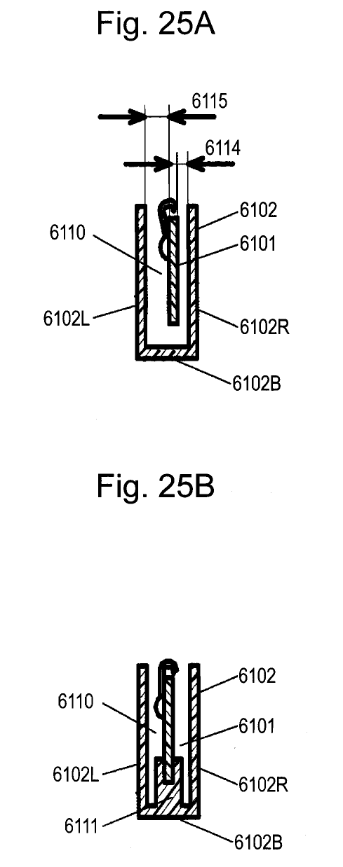

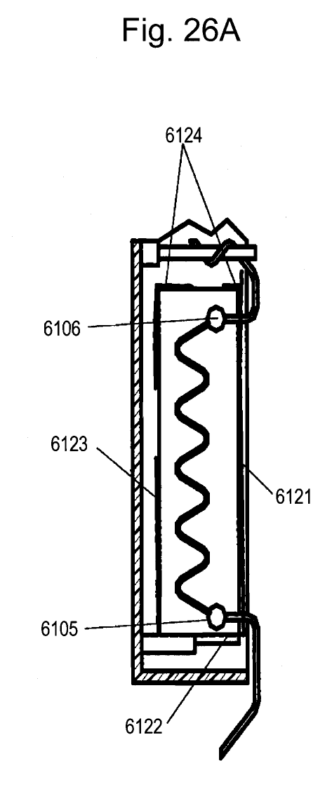

FIGS. 16A and 16B are a side view and a front view, respectively of high-voltage resistor 6001 which has cracks 6022, 6023, 6027, and 6028. These cracks have been generated during a long-term thermal shock test which is performed to apply continued and repeated thermal shock between high and low temperatures.

As insulating resin 6010, liquid epoxy resin having thermosetting properties is poured into case 6002 and outer case 6051, and then hardened at a high temperature. When the epoxy resin is hardened, transformer 7601 is at a high temperature inside and the components are stable and balanced in volume. Insulating substrate 6601 has a coefficient of linear expansion of 5×10⁻⁶/° C., which differs from the coefficient of linear expansion of 5×10⁻⁵/° C. of the epoxy resin. Therefore, when transformer 7601 changes from a high temperature to a low temperature, there occur gaps, that is, cracks 6022, 6023, 6027, and 6028 between insulating resin 6010 and insulating substrate 6601 in the vicinity of insulating substrate 6601. If insulating resin 6010 differs greatly in thickness on both sides of insulating substrate 6601, when transformer 7601 changes from a high temperature to a low temperature, insulating resin 6010 is contracted, causing shear stress to be applied in the vicinity of insulating substrate 6601. When the shear stress exceeds the strength of insulating resin 6010 or the interface strength between insulating resin 6010 and insulating substrate 6601, insulating resin 6010 may have cracks. A display device using a high-voltage transformer normally operates not continuously but intermittently. When in operation, the high-voltage transformer increases in temperature due to copper loss, iron loss, dielectric loss, and the heat generation in the resistive element. When not in operation, on the other hand, the high-voltage transformer decreases in temperature, thus being subjected to high and low temperatures repeatedly. When exposed to shear stress, insulating resin 6010 becomes likely to generate and grow cracks under such repeated high and low temperature conditions.

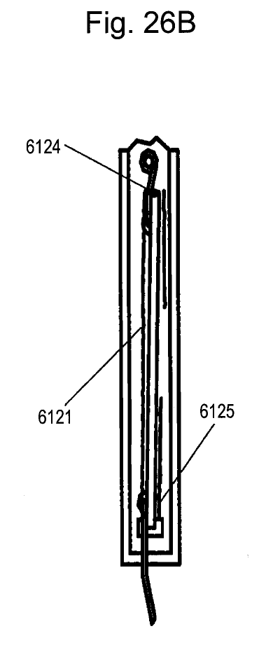

In high-voltage transformer 7601 of the fourth embodiment, as shown in FIG. 12, the top space of high-voltage resistor 6001 is closed by top wall 6002T of the box-shaped case 6002 surrounding high-voltage resistor 6001. This structure reduces the volume of insulating resin 6010 that is above high-voltage resistor 6001, thereby reducing shear stress applied to insulating resin 6010. As a result, cracks 6027 and 6028 shown in FIGS. 16A and 16B are smaller than crack 6124 caused in conventional high-voltage resistor 6101 shown in FIGS. 26A and 26B.

High-voltage resistor 6001 is disposed in such a manner that supporting rib 6011 and lower rib 6008 and upper rib 6009 do not cause high-voltage side end 6001B of high-voltage resistor 6001 to come into contact with case 6002. High-voltage resistor 6001 is positioned at the center of case 6002 so as to substantially balance the volume of insulating resin 6010 between both sides of high-voltage resistor 6001. Consequently, the shear stress generated when the temperature of thermosetting insulating resin 6010 decreases can be reduced and applied equally to high-voltage resistor 6001. This reduces cracks in the vicinity of high-voltage resistor 6001. This also reduces the growth of cracks that are caused due to repeated thermal shock between high and low temperatures while the high-voltage transformer is in operation. In other words, cracks 6121 and 6126 in the vicinity of the longitudinal surfaces of conventional high-voltage resistor 6101 of FIGS. 26A and 26B can be reduced in size to cracks 6022 and 6023 of FIGS. 16A and 16B.

The optimum widths of lower and upper ribs 6008 and 6009 are in the range of 1.0 mm to 3.0 mm. When these widths are smaller than 1.0 mm, ribs 6008 and 6009 are not required to have a high structural strength. When the widths are larger than 3.0 mm, on the other hand, insulating resin 6010 is likely to have cracks in the direction from ground-side electrode 6006 to high-voltage-side electrode 6007 of high-voltage resistor 6001 at the interface between insulating resin 6010 and the top ends of lower and upper ribs 6008, 6009.

In conventional high-voltage transformer 8601 of FIGS. 26A and 26B, it may happen that the cracks generated at the ground-side end and the high-voltage-side end of the insulating substrate of high-voltage resistor 6101 grow to become cracks 6121 and extend between ground-side electrode 6105 and high-voltage-side electrode 6106. In high-voltage transformer 7601 of the fourth embodiment, on the other hand, when repeated thermal shock is applied, as shown in FIGS. 16A and 16B, cracks occur at the ends of lower and upper ribs 6008 and 6009 which hold high-voltage resistor 6001, thereby causing crack 6021 in parallel with the longitudinal direction of ribs 6008 and 6009. Even if crack 6022 occurs along the end of high-voltage resistor 6001, crack 6021 disperses the shear stress caused by heat and stops the growth of crack 6022. Consequently, crack 6022 does not grow large enough to extend between ground-side electrode 6006 and high-voltage-side electrode 6007, thereby preventing a breakdown. The heights of lower and upper ribs 6008 and 6009 are made larger than the top surface of high-voltage resistor 6001. This allows crack 6021 to grow faster than crack 6022 so as to secure the prevention of the growth of crack 6022.

As shown in FIGS. 15A and 15B, about the lower one third of lower and upper ribs 6008 and 6009 are in contact with high-voltage resistor 6001, allowing high-voltage resistor 6001 to be positioned at the center of case 6002. Furthermore, the tapered portions corresponding to about the upper two thirds of lower and upper ribs 6008 and 6009 are provided to allow thermosetting insulating resin 6010 to be poured into between high-voltage resistor 6001 and lower and upper ribs 6008, 6009. The tapered portions prevent cracks 6021 and 6022 from propagating to the ends of high-voltage resistor 6001 along lower and upper ribs 6008 and 6009.

As shown in FIG. 14, lower and upper ribs 6008 and 6009 are provided between ground-side electrode 6006 and the position corresponding to about two thirds of the longitudinal length of high-voltage resistor 6001. Between high-voltage-side electrode 6007 and about one third of the longitudinal length of high-voltage resistor 6001, there are no components in contact with high-voltage resistor 6001 except insulating resin 6010.

High-voltage transformer 7601 thus structured has high resistance to thermal shock without an increase in the number of components, the space to store high-voltage resistor 6001, or the production cost.

High-voltage resistor 6001 of the fourth embodiment can be applied to high-voltage resistor 2801 of the high-voltage transformers of the first to third embodiments shown in FIGS. 1 to 10 to obtain the same effect.

### INDUSTRIAL APPLICABILITY

The diodes of the high-voltage transformer of the present invention are not required to be resistant to high voltage or high current, thus achieving a compact high-voltage transformer.

1. A high-voltage transformer comprising:
a core;
a primary coil bobbin surrounding the core;
a primary winding wound on the primary coil bobbin;
a secondary coil bobbin surrounding the core;
a secondary winding wound on the secondary coil bobbin, the secondary winding including a first partial secondary winding and a second partial secondary winding;
an insulator disposed between the first partial secondary winding and the second partial secondary winding of the secondary winding;
a plurality of diodes connected in parallel with each other between the first partial secondary winding and the second partial secondary winding of the secondary winding; and
a diode holder for holding the diodes arranged in a direction away from the core.

2. The high-voltage transformer of claim 1, further comprising:
a high-voltage resistor comprising:
an insulating substrate having a first surface and a second surface opposite to the first surface, and a first end and the second end opposite to the first end;
a high-voltage-side electrode which is disposed in a vicinity of the first end of the insulating substrate and connected to the secondary winding;
a ground-side electrode which is disposed in a vicinity of the second end of the insulating substrate and connected to a ground; and
a resistive element disposed on the insulating substrate and connected between the high-voltage-side electrode and the ground electrode;
a case for housing the high-voltage resistor;
a supporting rib formed in the case, the supporting rib having a recess for supporting the second end of the insulating substrate of the high-voltage resistor;
a first rib and a second rib for holding the high-voltage resistor to prevent the first end of the high-voltage resistor from coming into contact with the case, the first rib and the second rib protruding from the case, extending respectively parallel to the first surface and the second surface of the insulating substrate, and being in contact with respectively the first surface and the second surface of the insulating substrate of the high-voltage resistor; and
insulating resin poured into between the case and the high-voltage resistor.

3. The high-voltage transformer of claim 2, wherein
the case includes a bottom surface and a side wall extending from an outer periphery of the bottom surface; and
the first rib and the second rib extend from the bottom surface of the case beyond the high-voltage resistor in such a manner as not to be in contact with the side wall.

4. The high-voltage transformer of claim 3, wherein
the resistive element is disposed on the first surface of the insulating substrate;
a distance between the first rib and the ground-side electrode is shorter than a distance between the first rib and the high-voltage-side electrode;
a distance between the second rib and the high-voltage-side electrode is longer than one third of a distance between the first end and the second end of the insulating substrate.

5. The high-voltage transformer of claim 1, wherein
the diode holder includes a first rib and a second rib for holding the diodes therebetween.

6. The high-voltage transformer of claim 5, wherein
the diodes each includes:
an anode-side lead extending in a predetermined direction; and
a cathode-side lead extending in a direction opposite to the predetermined direction.

7. The high-voltage transformer of claim 6, further comprising:
a first terminal pin connected to an end of the first partial secondary winding of the secondary winding; and
a second terminal pin connected to an end of the second partial secondary winding of the secondary winding, wherein
the anode-side lead of each of the diodes has an end substantially parallel to the first terminal pin, and
the cathode-side lead of each of the diodes has an end substantially parallel to the second terminal pin.

8. The high-voltage transformer of claim 7, wherein
the diode holder includes:
an end holding part of a substantially square U shape, the end holding part having a groove surrounding the end of the cathode-side lead of each of the diodes from three sides; and
a rib surrounding the groove, the rib being thicker than the end holding part.

9. The high-voltage transformer of claim 6, wherein
the diode holder includes:
an end holding part of a substantially square U shape, the end holding part having a groove surrounding the end of the anode-side lead of each of the diodes from three sides; and
a holding rib surrounding the groove, the holding rib being thicker than the end holding part.
